(19) United States
(12) Patent Application Publication
(10) Pub. No.: US 2022/0226903 A1
(43) Pub. Date: Jul. 21, 2022

(54) METHOD FOR PRODUCING A METAL COMPONENT

(71) Applicant: RENA Technologies Austria GmbH, Wr. Neustadt (AT)

(72) Inventors: Wolfgang HANSAL, Markt Piesting (AT); Selma HANSAL, Markt Piesting (AT); Martin PFAFFENEDER-KMEN, Wien (AT); Gabriela SIRBU, Berndorf (AT); Martina HALMDIENST, Natschbach (AT)

(21) Appl. No.: 17/605,136

(22) PCT Filed: Apr. 24, 2020
(86) PCT No.: PCT/EP2020/061422

§ 371 Date: Oct. 20, 2021

(30) Foreign Application Priority Data
Apr. 25, 2019 (EP) 19171104.3

(51) Int. Cl. B22F 10/40; B33Y 10/00; B33Y 40/20; B22F 10/28; B22F 10/60

(52) U.S. Cl. CPC B22F 10/40; B33Y 10/00; B22F 10/60; B22F 10/28; B33Y 40/20

(57) ABSTRACT

A process for the manufacture of a metal component, wherein, in a first step, a raw metal component (A) with auxiliary structures (E) is produced by additive manufacture by applying metal powder to a building board (D) in an installation space, the metal powder being made into the raw metal component (A) by selective laser or electron beam melting, wherein the raw metal component (A) is attached to the building board (D) by means of anchor structures (B), wherein, in a second step, the raw metal component (A) attached to the building board (D) with the anchor structures (B) is subsequently removed from the installation space and then the raw metal component (A) attached to the building board (D) by means of anchor structures (B) is subjected to a chemical, electrochemical or chemical and electrochemical post-treatment to remove the auxiliary structures, whereupon the anchor structures (B) are mechanically removed in a third step.

The invention relates to a process for the manufacture of a metal component, wherein, in a first step, a raw metal component with auxiliary structures is produced by additive manufacture by applying metal powder to a building board in an installation space, which powder is made into the raw metal component by selective laser or electron beam melting.

### BACKGROUND OF THE INVENTION

Using so-called additive manufacturing processes, components are constructed, for example, from a powder. Therefore, they form a contrast to subtractive manufacturing processes (such as machining processes), in which components are manufactured from a larger part, for example, a block. Additive manufacturing has several advantages over conventional subtractive processes. Among other things, the rapid customizability of individual components as well as an extraordinary geometrical freedom should be mentioned in this connection. Suitable materials for the additive manufacture of metal components are titanium, aluminium, nickel-based alloys, cobalt chrome, copper, tungsten and other high-melting refractory metals, as well as steels and alloys of the metals described.

A major disadvantage of additive manufacturing processes is the complicated reworking of the raw components, in particular of metallic raw components that are melted from the powder bed. In such powder bed processes, a laser or electron beam scans the top layer of a metallic powder bed and thus fuses the individual metal particles of the powder bed. Subsequently, another layer of the metallic powder is applied and the process is repeated until the complete component has been constructed in the installation space.

It is necessary for various reasons that auxiliary structures are also generated in addition to the component during the construction process as described. On the one hand, they protect the component, among other things, from deformation caused by mechanical stress, and, on the other hand, they dissipate heat.

According to the prior art, the reworking of an additively generated component is effected such that the conglomeration composed of a component, a building board and an auxiliary structure is removed from the installation space and depowdered. Furthermore, the building board is separated from the component including auxiliary structures.

In some cases, a single or multi-stage heat treatment is also required in the course of the process chain. Thereupon, the auxiliary structures are removed mechanically using a hand grinder or perhaps a hammer and chisel. Ultimately, the surface of the component is polished (e.g., by sandblasting, vibratory grinding, electropolishing, etc.).

This mechanical type of post-processing is high risk, since the entire component can be rendered inoperable if the tool slips or becomes wedged. Furthermore, those complex manual operations prevent batch sizes that go beyond small series, as the process is then no longer economical.

Such a process is disclosed in EP 3 205 426 A1, for example. The powder-bed-based process disclosed therein describes an additive manufacture of a component with the aid of support structures also generated in the process, which are mechanically removed after the manufacture. In doing so, the support structures and the component are connected either with a powder layer or a minimal contact surface, which greatly simplifies the subsequent mechanical removal. However, this type of connection between support structures and component fails to enable the necessary mechanical strength for withstanding the mechanical stresses that occur in additive manufacturing.

### BRIEF DESCRIPTION OF THE INVENTION

It is therefore an object of the present invention to provide a process for the manufacture of metal components by means of an additive process, in which auxiliary structures can be removed by means of a reproducible, fully automated process.

This object is achieved by a process for the manufacture of a metal component, wherein, in a first step, a raw metal component with auxiliary structures is produced by additive manufacture by applying metal powder to a building board in an installation space, the metal powder being made into the raw metal component by selective laser or electron beam melting, wherein the raw metal component is attached to the building board by means of anchor structures, wherein, in a second step, the raw metal component attached to the building board with the anchor structures is subsequently removed from the installation space and then the raw metal component attached to the building board by means of anchor structures is subjected to a chemical, electrochemical or chemical and electrochemical post-treatment to remove the auxiliary structures, whereupon the anchor structures are mechanically removed in a third step.

For technical reasons, it is necessary that, in additive manufacturing (in which a metal powder is made into the component by selective laser or electron beam melting of the metal powder), so-called auxiliary structures are also generated in addition to the component in order to protect the component from deformation by mechanical stress and from excessive local temperature spikes.

Thus, in the context of the invention, auxiliary structures are understood to be
support structures, which stabilize the component against deformation or tipping over during the manufacture,
heat dissipation lugs, which ensure heat transport to the surface of the component during the manufacture, and/or
sinter cakes.

These auxiliary structures are removed in the second step during the chemical or electrochemical post-treatment.

The anchor structures are to be distinguished therefrom. It is their function to prevent the component from falling off the building board as soon as the auxiliary structures (in this case especially support structures or sinter cakes) have been removed. That is, according to the invention, the invention provides anchor structures which keep the component on the building board and survive the chemical or electrochemical post-treatment. Geometries with a low surface-to-volume ratio come into consideration as anchor structures, e.g., solid pillars.

The manufacture of the raw metal component in the first step takes place in such a way that a laser or electron beam scans and fuses the top layer of a metallic powder bed. Subsequently, another layer of the metallic powder is applied and the process is repeated until the complete component has been constructed in the installation space.

In a preferred embodiment variant, it is provided that the anchor structures are manufactured by selective laser or electron beam melting. This procedure involves the advantage that the metal component and the anchor structures can be manufactured simultaneously and in an automated manner. If, on the other hand, separately produced anchor structures are used, they must be placed precisely so that they are positioned in the correct places in the manufacturing process for the raw metal component with auxiliary structures via additive manufacturing. In this case, the anchor structures are also made of the same material as the component itself.

In the embodiment variants in which the anchor structures are made of the same material as the component, the density of the anchor structures is essentially the same as that of the component. Auxiliary structures, in this case especially the support structures or the sinter cake, are fused in powder bed processes generally with less energy so that they are more porous than the component. The density of these auxiliary structures is therefore less than the density of the component.

In one embodiment variant, it is provided that the building board is metallic and is electrically contacted when the raw metal component is subjected in the second step to the chemical, electrochemical or chemical and electrochemical post-treatment. Thus, the building board may additionally assume the function of an electrical conductor. Electrical contacting of the building board is preferred in the event of an electrochemical or chemical and electrochemical post-treatment.

In one embodiment variant, it is provided that the raw metal component is connected on the building board only by means of anchor structures, whereas the base of the raw metal component is not attached with the building board, i.e., remains free from connections.

Furthermore, it may be provided that the building board is provided with a protective layer after the first step and before the second step. Such a protective layer protects the building board in the subsequent step of the chemical and/or electrochemical post-treatment of the raw metal component.

The protective layer can be applied by painting, preferably immersion painting. For this purpose, the composite of the raw metal component and the building board is partially immersed in a bath with lacquer. In doing so, the composite of the raw metal component and the building board is immersed in the bath with lacquer with the building board at the lower side only until the building board is completely immersed in the lacquer and the raw metal component is not immersed in the lacquer.

As an alternative or, if necessary, in addition to the protective layer, the building board can be covered with a housing after the first step and before the second step. The housing can be made, for example, of a synthetic material such as, e.g., a polyolefin, preferably polypropylene (PP). Preferably, the housing seals the building board against the chemical and/or electrochemical post-treatment. In the event that the housing is provided in addition to the protective layer, the protective layer should be applied before the building board is covered with the housing.

Furthermore, it may be provided that at least one metal layer is applied beforehand to the building board, at least in the area in which auxiliary structures contact the building board, in that powder is made into the metal layer by selective laser or electron beam melting. In this case, the anchor structures are possibly attached indirectly to the building board, since the metal layer can, in this case, be located between the anchor structure and the building board. Optionally, several metal layers may also be applied between the auxiliary structures and the building board.

In order to ensure continuous automation of the process chain, the component should be located on the building board during the complete reworking. The latter then serves simultaneously as a goods support and, optionally, as an electrical contact for the individual process steps.

The auxiliary structures are porous grid-like structures which can be dissolved by a chemical or electrochemical attack in front of the component if the parameters are appropriately chosen. A mechanical removal of the auxiliary structures (e.g., by sandblasting) directly on the building board would be theoretically conceivable as long as the geometry of the component is not too complicated. As soon as there are areas on the component which are difficult or impossible to access, but need to be processed, mechanical reworking is no longer possible. With regard to additively manufactured components, it may be assumed in most cases that this is the case, since the geometrical freedom of the process is usually exploited.

If the auxiliary structures are to be dissolved chemically or electrochemically, the building board can act as a goods support and an electrical contact. In this case, there are generally two situations:

The building board is made of the same material as the component, or the building board is made of a different material than the component.

The building board can be protected by one or several welded layers of the same material as the component. Subsequently, the surface of the component can be refined directly on the building board by means of electropolishing, mechanical polishing or chemical polishing. Ultimately, the anchor structures are severed in order to separate the component and the building board.

The building board is then reused for a process for the manufacture of a metal component according to the invention.

The building board can be cleaned and/or chemically or mechanically smoothed beforehand.

In one embodiment variant, it is provided that the building board remains on the metal component. In this case, the anchor structures are indeed also removed after the manufacture, but the metal component has been manufactured on the building board in such a way that it is firmly connected to the building board. In this way, a hybrid component is produced which comprises a building board on which the additively manufactured component is attached. The building board might optionally have been produced in a previous step in a subtractive process or additive process. Since the building board is geometrically simpler than the additively manufactured component, a subtractive process is less expensive.

In the embodiment variant for the hybrid component, the raw metal component with auxiliary structures is therefore produced by additive manufacture in the first step by applying metal powder to a building board in an installation space, the metal powder being made into the raw metal component by selective laser or electron beam melting, wherein the raw metal component is attached to the building board by means of anchor structures and to the base of the raw metal component, wherein the anchor structures are mechanically removed in the third step and the finished metal component and the building board remain behind while being connected to the base of the component.

### DETAILED DESCRIPTION OF THE INVENTION

Advantageous embodiments, details and concrete examples of the invention are explained in detail below.

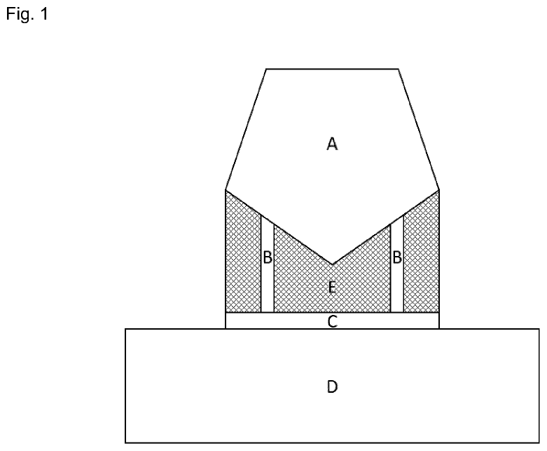

FIG. 1 schematically shows the structure of a component to be reworked on the building board.

FIG. 1 schematically shows an additively manufactured raw component A, which would have to be reworked within the meaning of the invention. The raw component A (made of material 1) is attached to the building board D (made of material 2) by means of anchor structures B (also made of material 1). In addition, at least one or several protective layers (again made of material 1) is/are also provided. Auxiliary structures E (also made of material 1) for mechanically supporting the raw component A can also be seen in FIG. 1.

In the first step, the raw metal component A with auxiliary structures E is produced by additive manufacturing by applying metal powder to a building board D in an installation space, the powder being made into the raw metal component A by selective laser or electron beam melting, wherein the raw metal component A is attached to the building board D by means of anchor structures B. This intermediate product can be seen in FIG. 1.

Subsequently, in the second step, the raw metal component A attached to the building board D by means of anchor structures B is removed from the installation space, and then the raw metal component A attached to the building board D by means of anchor structures B is subjected to a chemical or electrochemical or chemically/electrochemically combined post-treatment for removing the auxiliary structures E. In the final step, the anchor structures are removed mechanically so that the finished component, but also the building board D (separate from each other), remain behind.

One aspect of the invention thus relates to the post-processing of additively manufactured components directly on the building board. For this purpose, components are generated on a building board in an additive process (selective laser or electron beam melting from the powder bed). They are kept on the building board by solid anchor structures (e.g., support pillars). In addition to the anchor structures, there are grid-like auxiliary structures, which are mandatory for the construction process, on the building board, the component or, respectively, between the building board and the component. They are removed in a chemical or electrochemical process so that only the component, the building board and the anchor structures (support pillars) remain.

Depending on the process conditions, the building board should be protected from the process media. Under certain circumstances, the building board should indeed be available again after the process for another construction job. In this regard, there are three different cases:
The building board is made of the same material as the component. The material removal from the building board during the chemical or electrochemical post-treatment is usually much less than that of the auxiliary structures. In most cases, this material removal can be accepted, and the building board can optionally be reused for the next construction job after minor preparative operations after the anchor structures have been detached.
The building board is made of a different material than the component and is more inert relative to the process media than the component and the support structures. In this case, no further preparatory operations are required. The removal on the building board during the chemical or electrochemical post-treatment is negligible, and said board can be used for further construction jobs after the anchor structures have been detached.
The building board is made of a different material than the component and is attacked more strongly by the process media than the component and the support structures. In this case, it is advantageous if the building board is protected during preparatory operations.

One way to protect the building board is to paint it. Immersion painting can be fully automated and provides reproducible qualities. However, the spots on the building board underneath the support structures are problematic. They are difficult to reach with most lacquers, which are rather viscous, whereas aqueous electrolytes and process media get into the perforated support structures and attack the building board there.

To prevent this, one or several layers of the same material as the component must be melted onto the building board underneath the support structures during 3D printing. This layer must be thicker than the removal that is to be expected. The building board with the component and the support structures on it can be immersion-painted as described above in order to protect the remaining surfaces of the building board.

In addition to additively manufactured anchor structures, the component can also be constructed with the aid of external anchor structures. Then, the component must be hung up separately with the anchor structures so that it will not fall into the process tank or, respectively, so that an electrical contact is ensured. If the support structures are removed purely chemically, it is also possible not to hang up the part separately. A sieve or net would catch said part.

Upon removal of the support structures, the components can be polished directly on the building board. In doing so, the building board again serves as a goods support. In case of mechanical polishing methods such as, e.g., sandblasting, or other mechanical reworking operations such as, e.g., milling, the anchor structures must be designed appropriately so as to be mechanically resilient.

If the parts are to be polished chemically or electrochemically, the anchor structures serve as goods supports or electrical contacts, respectively. In this case, they have to be mechanically resilient to a lesser degree.

### Example 1

First, a raw metal component with auxiliary structures is additively manufactured on a building board. The raw metal component to be processed is composed of the component itself (stainless steel 316L), anchor structures (stainless steel 316L), auxiliary structures in the form of support structures (stainless steel 316L), a protective layer (stainless steel 316L) and a building board made of tool steel. The building board is first screwed on the rear side and contacted. The building board is immersion-coated so that it is completely covered, but the component itself does not come into contact with the lacquer. Thereupon, the auxiliary structure (support structure) is chemically removed with an aqueous solution consisting of 60% by volume of water, 40% by volume of H₂SO₄ and 100 g/l NH₄HF₂ in a solution at 30 to 80° C. for 60 to 240 minutes. Furthermore, the component is polished chemically or, respectively, electrochemically on the board. The anchor structures are severed, and their remains are mechanically removed from the component.

### Example 2

First, a raw metal component with auxiliary structures is additively manufactured on a building board. The raw metal component to be processed is composed of the component itself (Ti6Al4V), anchor structures (Ti6Al4V), auxiliary structures in the form of support structures (Ti6Al4V), a protective layer (Ti6Al4V) and a building board made of stainless steel. The building board is first screwed on the rear side and contacted. The building board is immersion-coated so that it is completely covered, but the component itself does not come into contact with the lacquer. Thereupon, the auxiliary structure (support structure) is electrochemically treated/removed in a solution of 60% by volume of water, 40% by volume of H₂SO₄ and 33.3 g/l NH₄HF₂ by applying for a period of 30 to 240 minutes alternately a voltage of 5 V for 1 to 4 seconds and of 25 V for 1 second at 20° C. Furthermore, the part is polished electrochemically. The anchor structures are severed, and their remains are mechanically removed from the component.

### Example 3

First, a raw metal component with auxiliary structures is additively manufactured on a building board. The raw metal component to be processed is composed of the component itself (Ti6Al4V), anchor structures (Ti6Al4V), auxiliary structures in the form of support structures (Ti6Al4V), a protective layer (Ti6Al4V) and a building board (Ti6Al4V). The building board is screwed on the rear side and contacted. In this case, it is not necessary to paint the building board. The auxiliary structure (support structure) is electrochemically treated/removed in a solution of 60% by volume of water, 40% by volume of H₂SO₄ and 33.3 g/l NH₄HF₂ by applying for a period of 30 to 240 minutes alternately a voltage of 5 V for 1 to 4 seconds and of 25 V for 1 second at 20° C. Furthermore, the component is polished by vibratory grinding. The anchor structures are severed, and their remains are mechanically removed from the component.

1. A process for the manufacture of a metal component,
wherein, in a first step, a raw metal component (A) with auxiliary structures (E) is produced by additive manufacture by applying metal powder to a building board (D) in an installation space, the metal powder being made into the raw metal component (A) by selective laser or electron beam melting,
wherein the raw metal component (A) is attached to the building board (D) by means of anchor structures (B),
wherein, in a second step, the raw metal component (A) attached to the building board (D) with the anchor structures (B) is subsequently removed from the installation space and then the raw metal component (A) attached to the building board (D) by means of anchor structures (B) is subjected to a chemical, electrochemical or chemical and electrochemical post-treatment to remove the auxiliary structures,
whereupon the anchor structures (B) are mechanically removed in a third step.

2. A process according to claim 1, wherein the anchor structures (B) are manufactured by selective laser or electron beam melting.

3. A process according to claim 1, wherein the building board (D) is metallic and is electrically contacted.

4. A process according to claim 1, wherein the building board (D) is provided with a protective layer after the first step and before the second step.

5. A process according to claim 4, wherein the protective layer is applied by painting.

6. A process according to claim 1, wherein the building board (D) is covered with a housing after the first step and before the second step.

7. A process according to claim 1, wherein at least one metal layer (C) is applied beforehand to the building board (D), at least in the area in which auxiliary structures (B) contact the building board (D), in that powder is made into the metal layer (C) by selective laser or electron beam melting.

8. A process according to claim 1, wherein the anchor structures (B) are mechanically removed in the third step in such a way that the finished metal component and the building board (D) remain behind separately.

9. A process according to claim 1, wherein the raw metal component (A) with auxiliary structures (E) is produced by additive manufacture in the first step by applying metal powder to a building board (D) in an installation space, the metal powder being made into the raw metal component (A) by selective laser or electron beam melting, wherein the raw metal component (A) is attached to the building board (D) by means of anchor structures (B) and to the base of the raw metal component (A), wherein the anchor structures (B) are mechanically removed in the third step and the finished metal component and the building board (D) remain behind while being connected to the base of the component.

10. A process according to claim 5, wherein the protective layer is applied by immersion painting.
